(19) United States
(12) Patent Application Publication
(10) Pub. No.: US 2017/0372375 A1
(43) Pub. Date: Dec. 28, 2017

(54) SYSTEM AND METHOD FOR PROVIDING ADVERTISEMENT PRODUCT

(71) Applicant: NHN Entertainment Corporation, Seongnam-si (KR)

(72) Inventor: Wu Sic WI, Seongnam-si (KR)

(21) Appl. No.: 15/632,502

(22) Filed: Jun. 26, 2017

(30) Foreign Application Priority Data
Jun. 28, 2016 (KR) 10-2016-0081053

(51) Int. Cl. G06Q 30/02; G06Q 30/06

(52) U.S. Cl. CPC G06Q 30/0269; G06Q 30/0641; G06Q 30/0242; G06Q 30/0255; G06Q 30/0277

(57) ABSTRACT

A computer-implemented method of providing an advertising product includes generating a plurality of segments by grouping similar users among a plurality of users based on a targeting condition of an advertiser; displaying a target advertising product of the advertiser for each segment of the plurality of segments; receiving feedback information according to display of the target advertising product for each segment of the plurality of segments; and adjusting the display of the target advertising product for each segment of the plurality of segments based on an efficiency of the feedback information.

### CROSS-REFERENCE TO RELATED APPLICATION

This application claims priority from and the benefit of Korean Patent Application No. 10-2016-0081053, filed Jun. 28, 2016, which is hereby incorporated by reference for all purposes as if fully set forth herein.

### BACKGROUND

### Field

The disclosure generally relates to technology for efficiently targeting, and, thereby, providing an advertisement product of an advertiser to at least one recipient.

### Discussion

With the popularization of the Internet, distribution and sales of goods and services using Internet shopping malls are or interest. Opportunities for mobile business using, for example, a smartphone, etc., are expanding, and mobile shopping markets are also on the rise. Advertisers typically use targeted advertising to efficiently advertise products of the advertisers. For example, a method and apparatus that allows an advertising providing server to display targeting advertisements using a cost-per-click (CPC) scheme is disclosed in Korean Patent No. 10-1430648, which issued on Aug. 18, 2014.

The above information disclosed in this section is only for enhancement of an understanding of the background of the inventive concepts, and, therefore, it may contain information that does not form prior art already known to a person of ordinary skill in the art.

### SUMMARY

Some exemplary embodiments are capable of providing a method and system to set an advertising-centered targeting and display an advertisement through media to efficiently and cost-effectively advertise an advertising product of an advertiser.

Some exemplary embodiments are capable of providing a method and system to receive an index associated with an advertisement displayed through media as feedback information, apply the index to a targeting advertising, and optimize a targeting.

Additional aspects will be set forth in the detailed description which follows, and, in part, will be apparent from the disclosure, or may be learned by practice of the inventive concepts.

According to some exemplary embodiments, a computer-implemented method of providing an advertising product includes: generating a plurality of segments by grouping similar users among a plurality of users based on a targeting condition of an advertiser; displaying a target advertising product of the advertiser for each segment of the plurality of segments; receiving feedback information according to display of the target advertising product for each segment of the plurality of segments; and adjusting the display of the target advertising product for each segment of the plurality of segments based on an efficiency of the feedback information.

According to some exemplary embodiments, a non-transitory computer-readable storage medium including instructions that, in response to being executed by a processor, cause the processor to perform a method of providing an advertising product, the method includes: generating a plurality of segments by grouping similar users among a plurality of users based on a targeting condition of an advertiser; displaying a target advertising product of the advertiser to each segment of the plurality of segments; receiving feedback information according to display of the target advertising product to each segment of the plurality of segments; and adjusting the display of the target advertising product for each segment of the plurality of segments based on an efficiency of the feedback information.

According to some exemplary embodiments, an advertising product providing system includes at least one processor and at least one memory. The at least one memory includes one or more sequences of one or more instructions that, in response to being executed by the at least one processor, cause the advertising product providing system at least to: generate a plurality of segments by grouping similar users among a plurality of users based on a targeting condition of an advertiser; control display of a target advertising product of the advertiser for each segment of the plurality of segments; receive feedback information according to the display of the target advertising product for each segment of the plurality of segments; and control adjustment of the display of the target advertising product for each segment of the plurality of segments based on an efficiency of the feedback information.

According to some exemplary embodiments, it is possible to sub-divide a target range by grouping users into a plurality of segments, by setting an advertising-centered targeting, and by displaying an advertisement through media in order to advertise an advertising product of an advertiser. In addition, according to some exemplary embodiments, it is possible to receive an index associated with an advertisement displayed through media, to apply the index to a targeting, and to provide a targeting advertising optimized for an optimization option desired by an advertiser. In this manner, it is possible to enhance an advertising efficiency. Furthermore, according to some exemplary embodiments, in lieu of a marketer, an advertising product providing system may apply feedback information and may retrieve an optimization point in time of a targeting advertising. As such, it is possible to perform a 24-hour work processing that is difficult and potentially cost-prohibitive for the marketer to perform and to efficiently perform a targeting advertising.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 illustrates an example of a network environment according to some exemplary embodiments.

FIG. 2 illustrates an example of an electronic device and a server according to some exemplary embodiments.

FIG. 3 illustrates an example of components of a processor of a server according to some exemplary embodiments.

FIG. 4 is a flowchart illustrating an example of a method performed at a server according to some exemplary embodiments.

FIG. 5 illustrates an example of generating a segment according to some exemplary embodiments.

FIG. 6 is a flowchart illustrating an example of a method to calculate a score for each user based on a logistic regression according to some exemplary embodiments.

FIG. 7 illustrates an example of a screen on which an advertiser registers a target advertising product desired to be campaigned according to some exemplary embodiments.

FIG. 8 illustrates an example of a configuration of a screen for setting a targeting condition according to some exemplary embodiments.

FIG. 9 illustrates an example of a screen for modifying advertising cost and bidding price of an advertising product for respective media according to some exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be implemented in another exemplary embodiment without departing from the spirit and the scope of the disclosure.

Unless otherwise specified, the illustrated exemplary embodiments are to be understood as providing exemplary features of varying detail of some exemplary embodiments. Therefore, unless otherwise specified, the features, components, modules, regions, aspects, etc. (hereinafter individually or collectively referred to as “elements”), of the various illustrations may be otherwise combined, separated, interchanged, and/or rearranged without departing from the spirit and the scope of the disclosure. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. Further, the D1-axis, the D2-axis, and the D3-axis are not limited to three axes of a rectangular coordinate system, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the spirit and scope of the inventive concepts. Further, the blocks, units, and/or modules of some exemplary embodiments may be physically combined into more complex blocks, units, and/or modules without departing from the spirit and scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

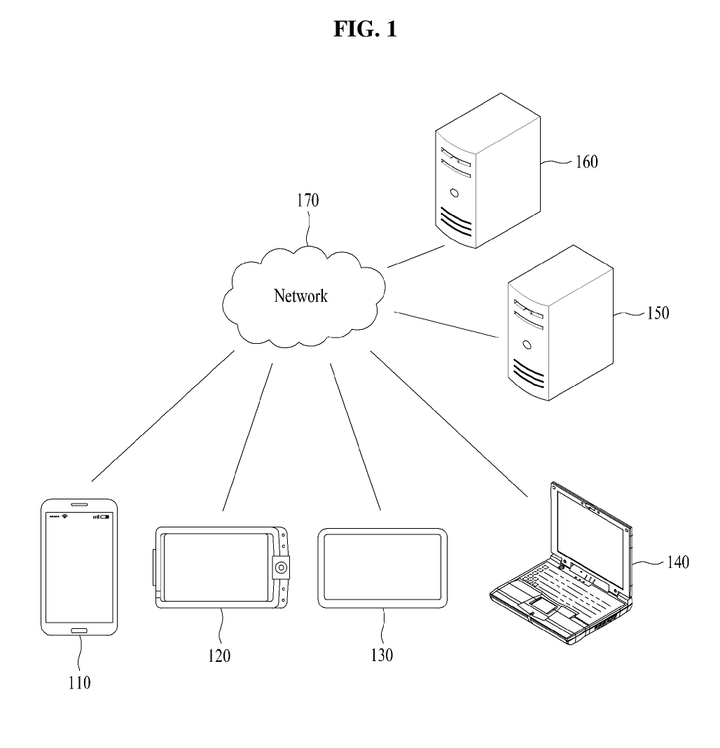

FIG. 1 illustrates an example of a network environment according to some exemplary embodiments.

Referring to FIG. 1, the network environment includes a plurality of electronic devices 110, 120, 130, and 140, a plurality of servers 150 and 160, and a network 170. The network environment of FIG. 1 is provided as an example only, and a number of electronic devices, a number of servers, and/or a number of networks are not limited thereto or thereby.

The plurality of electronic devices 110, 120, 130, and 140 may be fixed terminals and/or mobile terminals configured as computer devices. For example, the plurality of electronic devices 110, 120, 130, and 140 may be (or include) a smartphone, a mobile phone, a navigational module, a computer, a laptop computer, a digital broadcasting terminal, a personal digital assistant (PDA), a portable multimedia player (PMP), a tablet personal computer (PC), and/or the like. For example, the electronic device 110 may communicate with other electronic devices (e.g., electronic devices 120, 130, and/or 140) and/or the servers 150 and/or 160 over the network 170 in a wired communication manner and/or in a wireless communication manner.

The communication scheme is not particularly limited and may include a communication method that uses a near field communication scheme between devices as well as a communication method using a communication network, for example, a mobile communication network, the wired Internet, the wireless Internet, and a broadcasting network, etc., which may be included in (or as) the network 170. For example, the network 170 may include at least one of network topologies that include networks, for example, a personal area network (PAN), a local area network (LAN), a campus area network (CAN), a metropolitan area network (MAN), a wide area network (WAN), a broadband network (BBN), the Internet, and/or the like. Also, the network 170 may include at least one of network topologies that include a bus network, a star network, a ring network, a mesh network, a star-bus network, a tree or hierarchical network, and/or the like. It is contemplated, however, that the network 170 may include any suitable communication scheme and/or network topology.

Each of the servers 150 and 160 may be configured as a computer apparatus or a plurality of computer apparatuses that provides instructions, codes, files, contents, services, and/or the like, through communication with the plurality of electronic devices 110, 120, 130, and/or 140 over the network 170.

For example, the server 160 may provide a file for installing an application to the electronic device 110 connected over the network 170. In this case, the electronic device 110 may install the application using the file provided from the server 160. Also, the server 160 may connect to the server 150, and may receive a service or content provided from the server 150 under control of at least one program, for example, a browser or the installed application, and an OS included in the electronic device 110. For example, in response to a service request message that is transmitted from the electronic device 110 to the server 150 over the network 170 under control of the application, the server 150 may transmit a code corresponding to the service request message to the electronic device 110. The electronic device 110 may provide the content to the user by configuring and displaying a screen corresponding to the code under control of the application.

The server 150 may serve as an advertising platform. The advertising platform may indicate a system that is configured to bid for an advertising product, for example, content, which is provided as information data to an advertiser, to match between targeting elements for a user to which the content is to be provided, to align contents, to charge the advertiser for providing a publisher with the content and displaying the content, and/or the like. Here, the publisher indicates media for displaying contents, and may provide a path through which a user may directly receive content. In a general online environment, contents may be displayed through a website/mobile site. Herein, the server 150 may serve as an advertising platform to provide an advertisement of the advertiser for each targeted segment through a publisher that is media for displaying advertisements. In a general online environment, advertisements may be provided through an Internet website/mobile website. As such, the terms “publisher” and “site” may be used interchangeably.

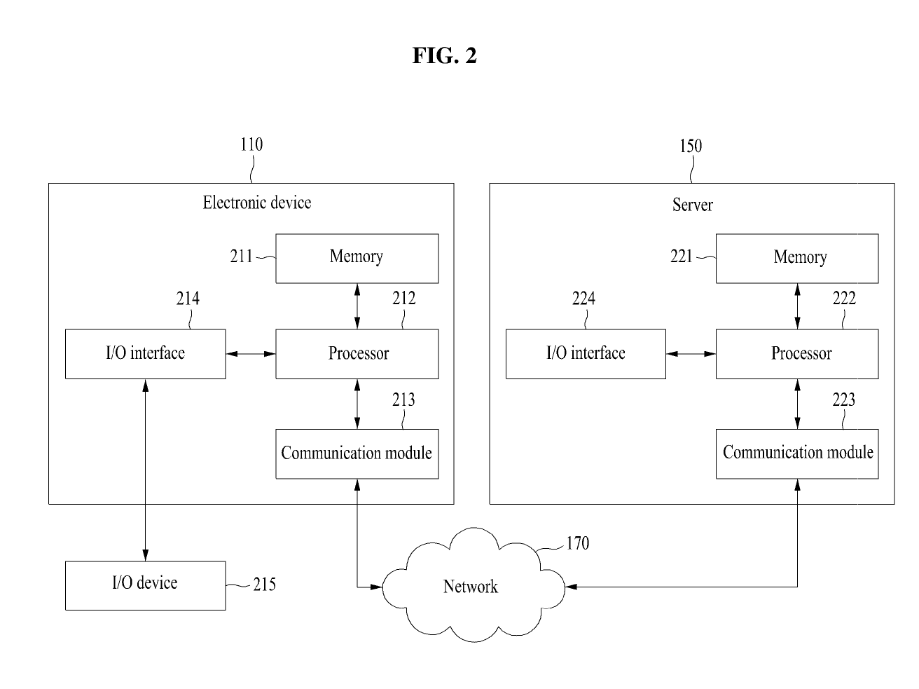

FIG. 2 illustrates an example of a configuration of an electronic device and a server according to some exemplary embodiments. That is, FIG. 2 illustrates a configuration of the electronic device 110 as an example of a single electronic device and illustrates a configuration of the server 150 as an example of a single server. The same or similar components may be applicable to other electronic devices 120, 130, and/or 140, and/or the server 160, and also to still other electronic devices or still other servers.

Referring to FIG. 2, the electronic device 110 may include a memory 211, a processor 212, a communication module 213, and an input/output (I/O) interface 214. The server 150 may include a memory 221, a processor 222, a communication module 223, and an I/O interface 224. Each of the memories 211 and 221 may include a permanent mass storage device, such as random access memory (RAM), read only memory (ROM), a disk drive, etc., as a computer-readable storage medium. Here, ROM and the permanent mass storage device may be included as a separate permanent storage device, separate from the corresponding memory 211 and 221. Also, an OS and at least one program code, for example, a code for a browser installed and executed on the electronic device 110, an application for a video call, etc., may be stored in at least one of the memories 211 and 221. Such software components may be loaded from another computer-readable storage medium separate from the at least one memory 211 and 221 using a drive mechanism. The other computer-readable storage medium may include, for example, a floppy drive, a disk, a tape, a DVD/CD-ROM drive, a memory card, etc. According to some exemplary embodiments, software components may be loaded to the at least one memory 211 and 221 through at least one of the communication modules 213 and 223, instead of, or in addition to, the computer-readable storage medium. For example, at least one program may be loaded to the at least one memory 211 and 221 based on a program, for example, the application, installed by files provided over the network 170 from developers or a file distribution system, for example, the server 160, which provides an installation file of the application.

Each of the processors 212 and 222 may be configured to process computer-readable instructions by performing basic arithmetic operations, logic operations, and I/O operations. The computer-readable instructions may be provided from a memory (e.g., at least one of the memories 211 and 221) and/or a communication module (e.g., at least one of communication modules 213 and 223) to the processor 212 and/or 222. For example, the processor 212 or 222 may be configured to execute received instructions in response to the program code stored in a storage device, such as the memory 211 and/or 222.

Each of the communication modules 213 and 223 may provide a function for communication between the electronic device 110 and the server 150 over the network 170, and may provide a function for communication with another electronic device, for example, the electronic device 120 or another server, for example, the server 160. For example, the processor 212 of the electronic device 110 may transfer a request, for example, a request for a video call service, created based on a program code stored in the storage device, such as the memory 211, to the server 150 over the network 170 under control of the communication module 213. As another example, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, etc., of the server 150 received through the communication module 213 may be transferred to the processor 212 or the memory 211, and content, a file, etc., may be stored in a storage medium further included in or accessible to the electronic device 110.

Each of the I/O interfaces 214 and 224 may be a device used for interface with an I/O device, such as I/O device 215. For example, an input device may include a keyboard, a mouse, etc., and an output device may include a device, such as a display for displaying a communication session of an application. As another example, the I/O interface 214 may be a device for interface with an apparatus in which an input function and an output function are integrated into a single device, such as a touch screen. For instance, when processing instructions of the computer program loaded to the memory 211, the processor 212 of the electronic device 110 may display a service screen configured using data provided from the server 150 or the electronic device 120, or may display content on a display through the I/O interface 214.

According to some exemplary embodiments, the electronic device 110 and the server 150 may include a greater or lesser number of components than the number of components shown in FIG. 2; however, to avoid obscuring exemplary embodiments, the electronic device 110 and the server 150 have been described and illustrated in one of various configurations. For example, the electronic device 110 may include at least a portion of the I/O device 215, or may further include other components, for example, a transceiver, a global positioning system (GPS) module, a camera, a variety of sensors, a database, and/or the like. For instance, in a smartphone implementation of the electronic device 110, the electronic device 110 may be configured to further include a variety of components, for example, an accelerometer sensor, a gyro sensor, a camera, various physical buttons, a button using a touch panel, an I/O port, a vibrator for vibration, etc., which are generally included in a smartphone.

Some exemplary embodiments relate to technology for sub-dividing and setting an advertising-centered (i.e., advertiser-centered) targeting range using a segment unit based on a data management platform (DMP) that stores and maintains data collected through the network 170, an application (app) of a game, etc., primarily displaying a targeting advertising through media such as a publisher, and receiving an index according to displaying of an advertisement and applying the index to a targeting, and secondarily providing a targeting advertising optimized for a desired optimization option of the advertiser. In this manner, some exemplary embodiments are not directed to a user-centered targeting range.

Herein, the term “index” includes any type of index indicating an advertising efficiency of an advertising product displayed through a mobile web or website, and may include, for example, a click-through ratio, a click cost, a conversion rate, a conversion cost, a return-on-ads spending (ROAS), a number of executions, a number of displays, a number of clicks, a number of conversions, a cost-per-click (CPC), a cost-per-install (CPI), a cost-per-action (CPA), a cost-per-engagement (CPE), a cost-per-view (CPV), a proportion of a number of user influxes, a proportion of a number of conversions, a proportion of a number of direct conversions, a proportion of a number of indirect conversions, and/or the like.

Herein, the term “user” may indicate a user terminal, for example, a smartphone, a tablet PC, a laptop computer, a desktop computer, and/or the like, that is owned (or substantially owned) by the user or used (or substantially used) by the user. Further, as used herein, the term “advertiser” may indicate an advertiser terminal, for example, a smartphone, a tablet PC, a laptop computer, a desktop computer, and/or the like, that is owned (or substantially owned) by the advertiser or used (or substantially used) by the advertiser.

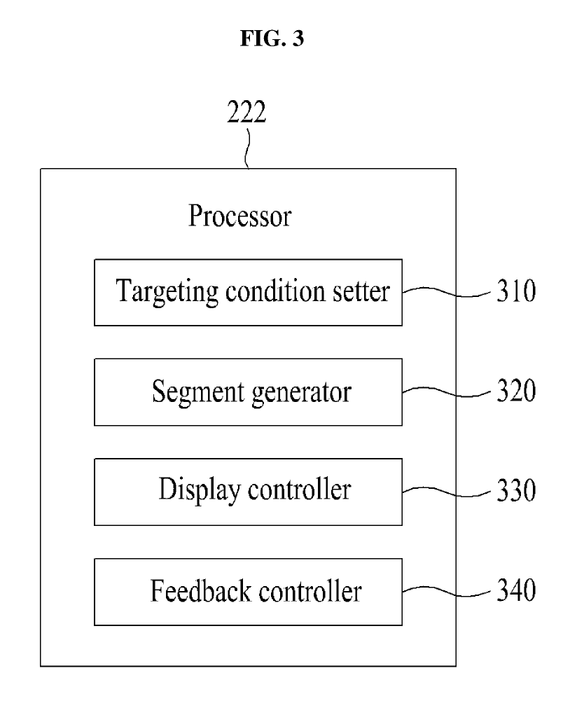

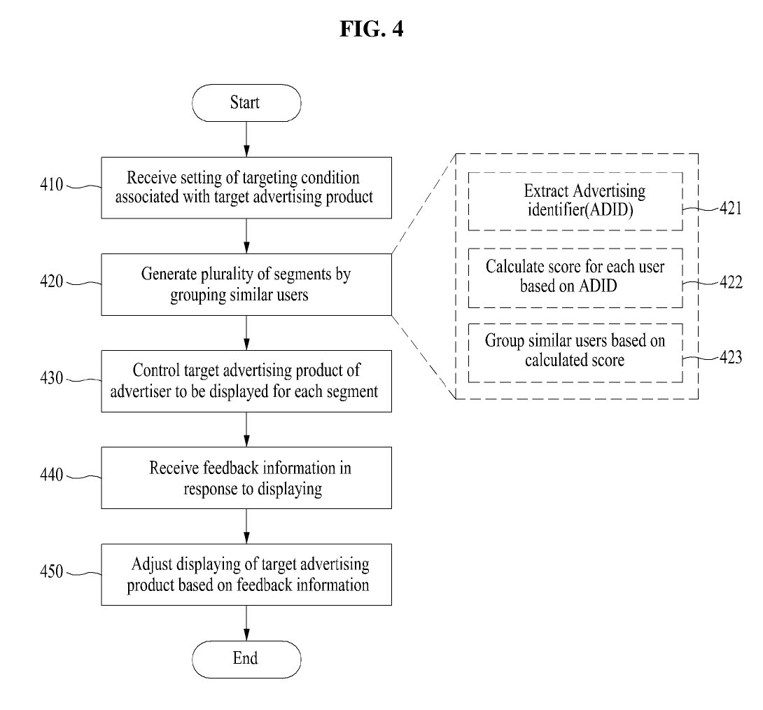

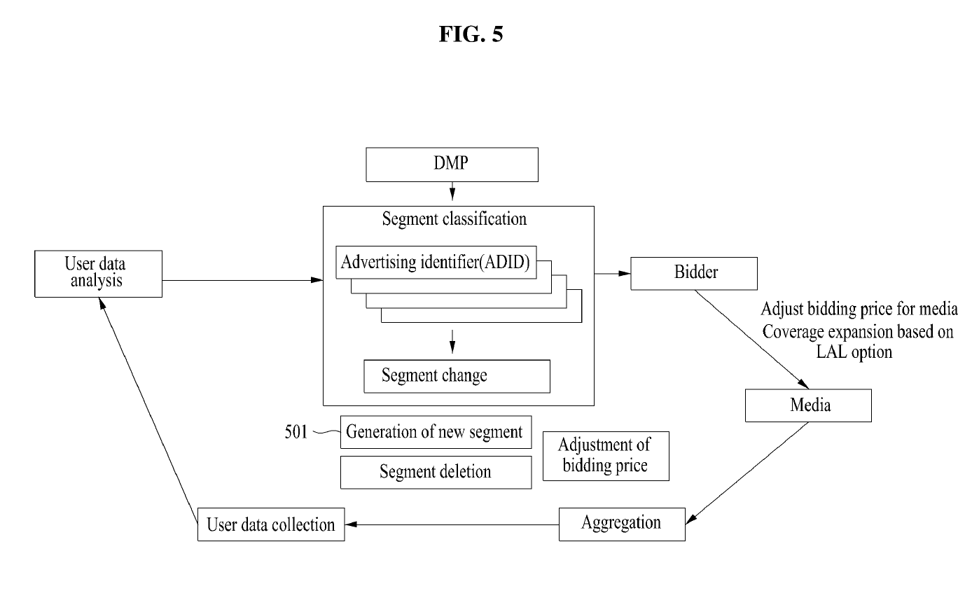

FIG. 3 illustrates an example of components of a processor of a server according to some exemplary embodiments. FIG. 4 is a flowchart illustrating an example of a method performed at a server according to some exemplary embodiments. FIG. 5 illustrates an example of generating a segment according to some exemplary embodiments.

Referring to FIG. 3, the processor 222 of the server 150 may include a targeting condition setter 310, a segment generator 320, a display controller 330, and a feedback controller 340 as components. The processor 222 and the components of the processor 222 may control the server 150 to perform operations 410 through 450 included in the method of FIG. 4 and the illustrated process of FIG. 5. Here, the processor 222 and the components of the processor 222 may be configured to execute one or more sequences of one or more instructions according to a code of at least one program and a code of an OS included in, for instance, the memory 221 or other storage of or accessible to the server 150. Also, the components of the processor 222 may be representations of different functions performed by the processor 222 in response to a control instruction provided from the OS or the at least one program. For example, the segment generator 320 may be used as a functional representation that controls the processor 222 to generate a segment according to the control instruction.

In operation 410, the targeting condition setter 310 may provide an advertiser with a screen for setting a targeting condition and may receive a setting of a targeting condition associated with a target advertising product from the advertiser.

For example, the advertiser may designate a new app or an app that the advertiser desires to advertise among existing apps. The targeting condition setter 310 may match and store identifier (ID) information used for identifying a designated app with an indicator that indicates a campaign app designation. In addition, the advertiser may set a budget used for advertising the designated app, a target option, and an optimization option, and the targeting condition setter 310 may match and store an indicator that indicates each option with set information. Here, the budget may be sub-divided into an entire term budget, a daily budget, etc. The target option may include a gender, an age zone, a time zone, a matter of interest, a keyword, etc. The optimization option may include an installation optimization indicating an installation of an advertising app corresponding to an advertising product, a sales optimization indicating a purchase of a corresponding advertising product by clicking the advertising product, a click optimization, etc.

In operation 420, once the targeting condition associated with the designated advertising app is set and registered, the segment generator 320 may generate a plurality of segments by grouping similar users among users based on the set targeting condition of the advertiser. User data collected through the network 170, an app, such as a game, etc., may be matched to user ID information, and, thereby, stored and maintained on a data management platform (DMP). For example, an advertising identifier (ADID) allocated in advance to each user may be used as user ID information. Data including a history, such as that a user clicks an advertising product and installs a specific app, or that the user purchases a product through the advertising product, or that the user clicks the advertising product, may be matched to an ADID of the corresponding user, and, thereby, stored and maintained on the DMP. That is, a user log including all of (or various) actions of the user, such as a click, a product purchase, an app installation, etc., may be matched to an ADID, and, thereby, stored and maintained in association with an advertising product that is displayed for the user through a mobile website or an Internet website.

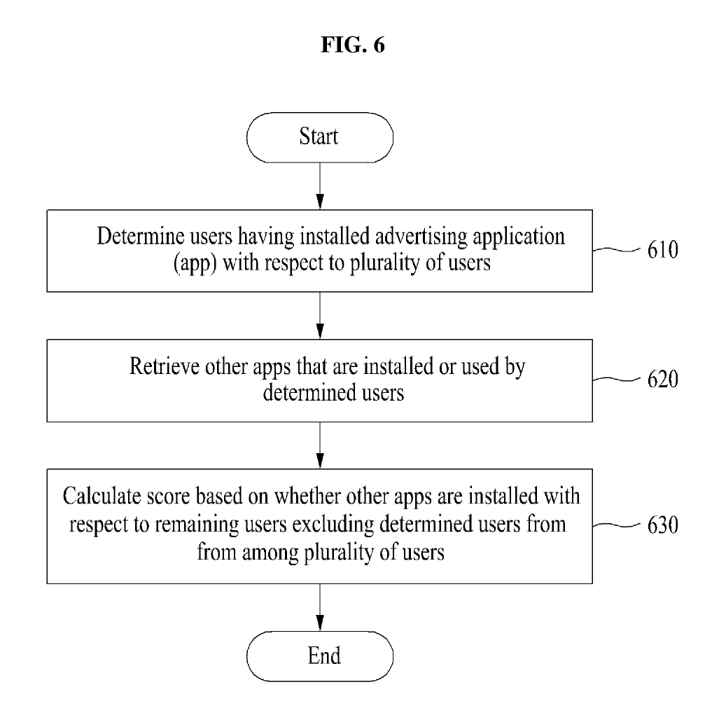

In association with the generation of the plurality of segments, the segment generator 320, in operation 421, may extract the ADID that is the user ID information from collected user data. In operation 422, the segment generator 320 may calculate (or determine) a score for each user based on the user data and the targeting condition set by the advertiser. For instance, a relatively high score may be calculated for a user having a high probability of meeting a targeting condition set and desired by the advertiser. A relatively low score may be calculated for a user having a low probability of meeting the targeting condition. Here, the segment generator 320 may calculate the score, that is, scoring, for each user based on a logistic regression analysis. An operation of performing scoring will be described in more detail with reference to FIG. 6.

In operation 423, the segment generator 320 may group similar users for each segment based on the calculated score. The segment generator 320 may group similar users by further considering at least one of target options that include a gender, an age, a time zone, and like, and may generate a segment.

For example, if a gender and an age are applied, the segment generator 320 may select women in their twenties from among the plurality of users. The segment generator 320 may group users having a score greater than or equal to a determined value among women in their twenties, and may generate the groped users into segment 1. For example, if the advertiser sets a target option as a woman in her twenties and an optimization option as an installation optimization, a user that clicks an advertising product and performs an installation based on the installation optimization may have a relatively high score. Users having a score greater than or equal to a specific value may be grouped into segment 1.

As another example, if an age and a time zone are applied, the segment generator 320 may select users from their twenties to their forties from among the plurality of users, and may select users that perform an operation of selecting and purchasing an advertising product in a determined time zone, for example, a lunch time based on ADID of each user. The segment generator 320 may generate segment 2 by grouping users that perform a conversion, such as a product purchase, an app installation, and the like, through advertising a determined number of times or more during a lunch time, e.g. from 11:30 to 1:30, among the users from their twenties their forties. Here, the segment generator 320 may generate segment 2 by additionally applying a score and by regrouping users having a score greater than or equal to a determined value among the grouped users.

In operation 430, the display controller 330 may control a target advertising product of the advertiser to be displayed through a publisher, for example, a website and a mobile website, for each segment. For instance, the target advertising product of the advertiser may be displayed for each segment that is generated through grouping based on the targeting condition primarily set by the advertiser. For example, if the advertiser sets a target option as a woman in her twenties and an optimization option as an installation optimization, the display controller 330 may control the target advertising product of the advertiser to be displayed on segment 1. That is, the display controller 330 may control the target advertising product to be displayed for users grouped into segment 1 through the publisher.

In operation 440, the feedback controller 340 may receive, from each user as feedback information, an index indicating an advertising efficiency that occurs in response to the display of the target advertising product. Here, the feedback controller 340 may receive, as feedback information, information about a number of displays indicating a number of times that the target advertising product is displayed based on a segment unit. The feedback controller 340 may receive, as feedback information, a number of clicks on the displayed target advertising product based on a segment unit, and may receive, as feedback information, a number of installations of an advertising app and sales information corresponding to the target advertising product for each ADID, that is, for each user.

In operation 450, the display controller 330 may adjust the display of the target advertising product based on the feedback information. For instance, the display controller 330 may determine again a segment on which the target advertising product is to be displayed among a plurality of segments based on the feedback information and may control the target advertising product to be displayed on the determined segment. For example, although the target advertising product is displayed on segment 1, the number of installations of the advertising app and sales over the number of displays may be low based on feedback information. That is, a conversion rate may be less than a reference conversion rate. In this case, the display controller 330 may control the target advertising product to be displayed on another segment, for example, segment 2, aside from segment 1. In addition, the display controller 330 may additionally generate a new segment and may display a target advertising app on the new segment.

The target advertising product may be displayed on a single segment and may also be displayed on a plurality of segments. When the target advertising product is displayed on the plurality of segments, the display controller 330 may suspend the display of an advertising product on a segment of which an advertising efficiency, e.g., performance, is less than a reference efficiency among the plurality of segments, and may continuously display the advertisement product or increase the number of displays on a segment of which an advertising efficiency is greater than or equal to a reference efficiency or a reference performance.

For example, the target advertising product may be displayed on each of segment 1, segment 2, and segment 3, and the number of displays of the target advertising product for each segment may be fed back as 1,000 times. Further, the number of clicks may be fed back as 10,000 clicks for segment 1, 5,000 clicks for segment 2, and 1,000 clicks for segment 3. The number of installations may be fed back as 6,000 installations of ADIDs (e.g., an advertising app installed in 6,000 users) with respect to users that are included in segment 1, 4,000 installations for segment 2, and 100 installations for segment 3. In this example, segment 3 corresponding to the lowest number of installations over the number of displays may be regarded to have the lowest advertising efficiency and segment 1 corresponding to the highest number of installations over the number of displays may be regarded to have the highest advertising efficiency. The display controller 330 may adjust a segment on which the target advertising product is displayed in order to perform secondarily further effective targeting based on feedback information. For instance, the display controller 330 may transfer all of the remaining advertising budget of segment 3 to segment 1 and may increase the number of displays, e.g., the number of times that the target advertising product is displayed on segment 1. Accordingly, display of the target advertising product on segment 3 may be suspended.

As another example, the display controller 300 may control the display of the target advertising product to be suspended on a segment of which the number of installations over the number of displays (number of installations per number of displays) is less than ½ of a defined reference value based on feedback information of each segment, and may control the target advertising product to be continuously displayed on a segment of which the number of installations over the number of displays is greater than or equal to ½. The display controller 320 may allocate the total budget of a segment on which the displaying is suspended to a segment corresponding to the highest advertising efficiency (e.g., number of installations/number of displays) and may increase the number of displays, or may distribute the budget in descending order of the advertising efficiency among segments on which the display is maintained and may increase the number of displays.

As described above, the display controller 330 may receive the advertising efficiency that is a display-based index as feedback information in real time (e.g., dynamically), and may apply the received feedback information to the target advertising product. In this manner, the display controller 330 may retrieve a segment further optimized for an advertisement of the advertiser at a subsequent targeting point in time and may control the target advertising product of the advertiser to be displayed on the segment.

In some exemplary embodiments, the display controller 330 may adjust a bidding price for each segment based on an advertising efficiency, e.g., performance, according to the display of the target advertising product. For example, the display controller 330 may adjust a lowest bidding price of a corresponding segment to increase by each single stage sequentially from a determined level according to an increase in an advertising efficiency, and may adjust the lowest bidding price of the corresponding segment to decrease by each single stage sequentially from a determined level according to a decrease in the advertising efficiency.

Also, all of the plurality of segments on which the target advertising product is displayed may have a low advertising efficiency. For example, the number of installations over the number of displays may be less than ½ with respect to segment 1, segment 2, and segment 3. In this case, referring to FIG. 5, the segment generator 320 may generate a new segment 501 with respect to newly collected users without using the existing generated segments, e.g., segment 1, segment 2, and segment 3. Here, when generating the new segment 501, a process of generating a segment by calculating a score and grouping similar users based on the score may be the same as the existing segment generation process. For example, new segment 4 may be generated by grouping similar users based on scores calculated for the newly collected users. The display controller 330 may control the target advertising product to be displayed for users of new segment 4 through a publisher. An example of calculating a score based on whether an advertising app corresponding to a target advertising product is installed if an advertiser sets an optimization option as an installation optimization is described with reference to FIG. 6. In addition to an installation/non-installation of the advertising app, whether demonstration information is present may be used.

FIG. 6 is a flowchart illustrating an example of a method to calculate a score for each user based on a logistic regression according to some exemplary embodiments.

Referring to FIG. 6, in operation 610, the segment generator 320 may determine users having installed the advertising app by analyzing a user log based on an ADID of each user with respect to the plurality of users that are collected in a DMP. In operation 620, the segment generator 320 may retrieve other apps that are installed or used in addition to the advertising app, based on ADIDs of the determined users. In operation 630, the segment generator 320 may calculate a score for each user based on whether the other apps are installed with respect to remaining users excluding the determined users from among the plurality of users, e.g., users that have not installed the advertising app. The segment generator 320 may calculate a score for each user based on a logistic regression analysis as shown in Equation 1.

Advertising app installation probability=F(ΣAiXi) Eq. 1

In Equation 1, Ai denotes a weight assigned to each piece of information as a value found by learning a model and Xi denotes a value assigned as a point based on an installation of the advertising app that is user information. A probability that the target advertising app of the advertiser is to be installed may be calculated as a score for each user. If the score is high (e.g., greater than a threshold value), the installation probability of the target advertising app may increase. Thus, a segment may be generated by grouping users corresponding to a score greater than or equal to a determined level.

To this end, the segment generator 320 may calculate the score, e.g., scoring, for each user based on a logistic regression analysis using Equation 1. For example, with respect to users that have not installed the advertising app, a score of a corresponding ADID may be calculated by adding 1 point if found other apps are installed, and otherwise, by adding zero points, and by summing up all of the added points. For example, the score may be calculated as 8 points if eight apps among the found other apps, for example, ten apps, are installed, and may be calculated as 6 points if six apps are installed.

As described above, the score for each user may be calculated by applying a weight to users having installed other apps among users having not installed the advertising app based on the other apps installed by a user having installed the advertising app and by summing up the points. The segment may be generated by grouping similar users based on the calculated score.

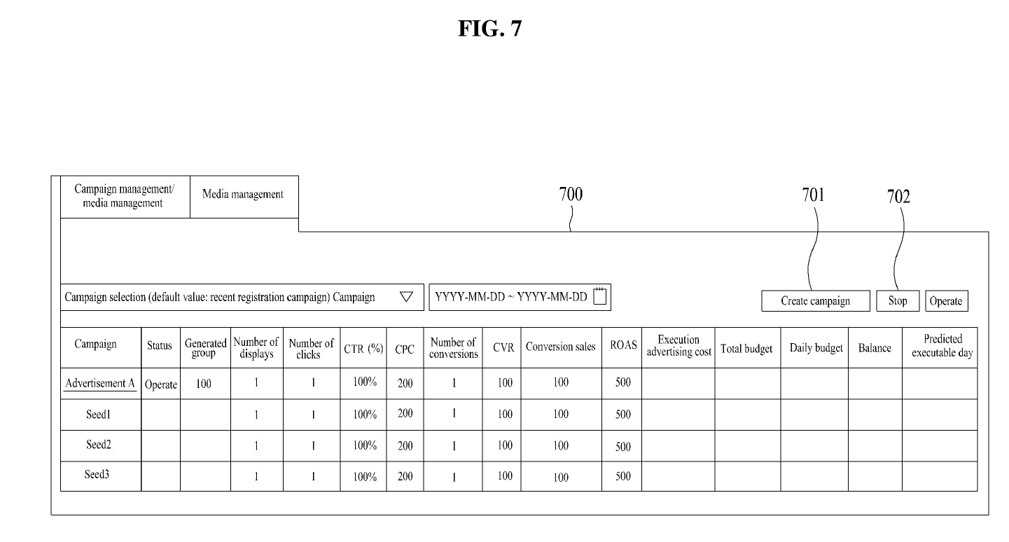

FIG. 7 illustrates an example of a screen on which an advertiser registers a target advertising product desired to be campaigned according to some exemplary embodiments.

Referring to FIG. 7, the targeting condition setter 310 may provide an advertiser with a screen 700 for registering a target advertising product on which the advertiser desires to perform targeting advertising. The screen 700 may include an indicator 701 for receiving information associated with advertisements of the advertiser that are registered so far and registration of a new advertisement, and an indicator 702 for suspending displaying of a registered advertisement. Information associated with an advertisement may include any type of index representing an advertising efficiency of an advertising product of the advertiser, and may include, for example, a number of generated segments (generated group), a conversion rate (CVR), a conversion cost, a return-on-ads spending (ROAS), a number of displays, a number of clicks, a number of conversions, a click through ratio (CTR), a cost-per-click (CPC), an execution advertising cost, a total budget, a daily budget, a balance, a predicted executable day, and/or the like.

In FIG. 7, the conversion rate (CVR) may be defined to be <conversion rate (%)={number of conversions/number of user influxes(number of clicks)}×100> as an index indicating a ratio of users that visit a site through a specific advertising product and generate a conversion, such as a purchase, a membership signup, and/or the like. For example, if 5,000 users click a specific product and 100 conversions occur, the conversion rate is calculated as 2%. That is, an occurrence ratio of an action desired by the advertiser over a number of times that the advertising product is displayed may be represented as the conversation rate.

The conversion cost (CPA) may be defined to be <conversion cost(won)=advertising cost/number of conversions> as an index indicating cost that occurs per single conversion. For example, if a total of advertising cost of a specific product is 1 million won and 100 conversions occur, the conversion cost is calculated as 10,000 won.

The ROAS may be defined as <ROAS (%)=(sales/advertising cost)×100> as an index indicating sales over advertising cost. For example, if a total of advertising cost of a specific product is 1 million won and sales of 10 million won occurs, the ROAS is calculated as 1,000%.

The number of displays may represent an index indicating a number of times that a specific product is displayed, the number of clicks may represent an index indicating a number of times that users click the specific product, and the number of conversions may represent an index indicating the number of conversions to a purchase, a membership signup, an application installation, and/or the like with respect to the specific product.

The CPC and the conversion cost (CPA) relate to advertising cost indices that are used to determine advertising cost, and may represent the advertising cost indices that are used to determine the advertising cost based on a number of clicks on an advertising product, a number of installations of related software (mobile application, etc.), and a number of executions/the number of installations of related software (for example, an advertising app, etc.)

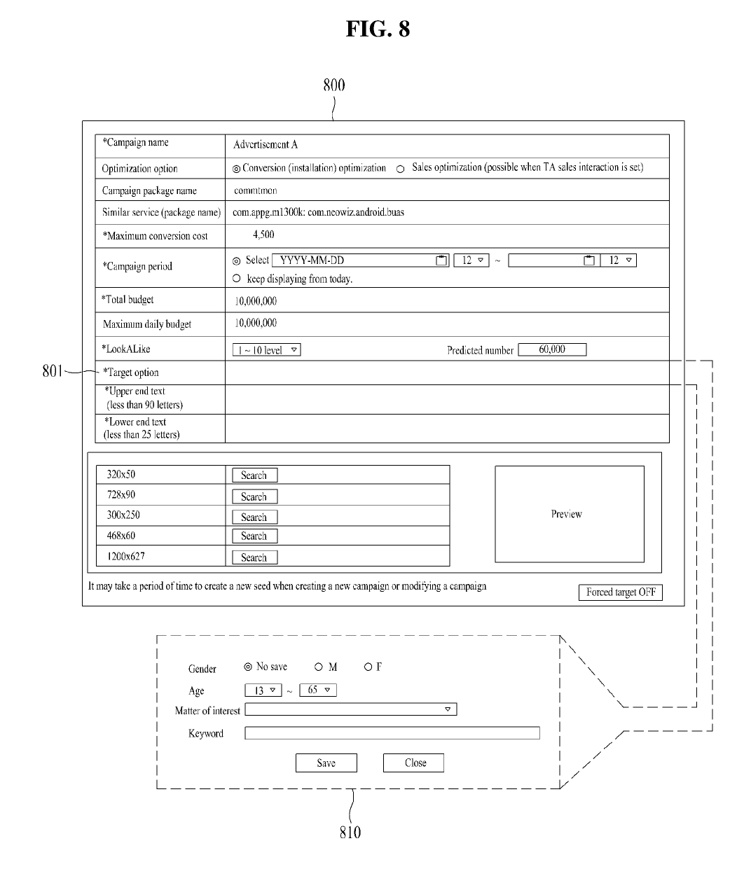

FIG. 8 illustrates an example of a configuration of a screen for setting a targeting condition according to some exemplary embodiments

If the advertiser desires to proceed with a campaign on advertisement A as shown in FIG. 7, a targeting condition for the advertisement A may be set through a screen 800. For example, in response to a selection on an area corresponding to the advertisement A on the screen 700 of FIG. 7, the screen 700 may be switched to the screen 800 for setting the targeting condition. The advertiser may set the targeting condition, such as an optimization option, a total budget, a daily budget, a maximum conversion cost, a campaign period, a gender, a target option, and/or the like, through the screen 800. Also, coverage may be expanded using a Look-a-Like (LAL) option. For example, if an LAL level increases from level 1 to level 10, it indicates that a similarity increases. For instance, the coverage may be expanded according to an increase in the LAL level.

A screen 810 for setting a gender, an age, a matter of interest, a keyword, and/or the like, that are parameters used for grouping users for which the advertiser desires to display the target advertising product may be provided in response to a selection on a target option 801.

Advertising cost and bidding price can be automatically set for the respective (publisher) through which an advertising product is displayed. Also, a marketer may manually modify the advertising cost and the bidding price. Accordingly, a screen for modifying the advertising cost and the bidding price may be provided for the respective media.

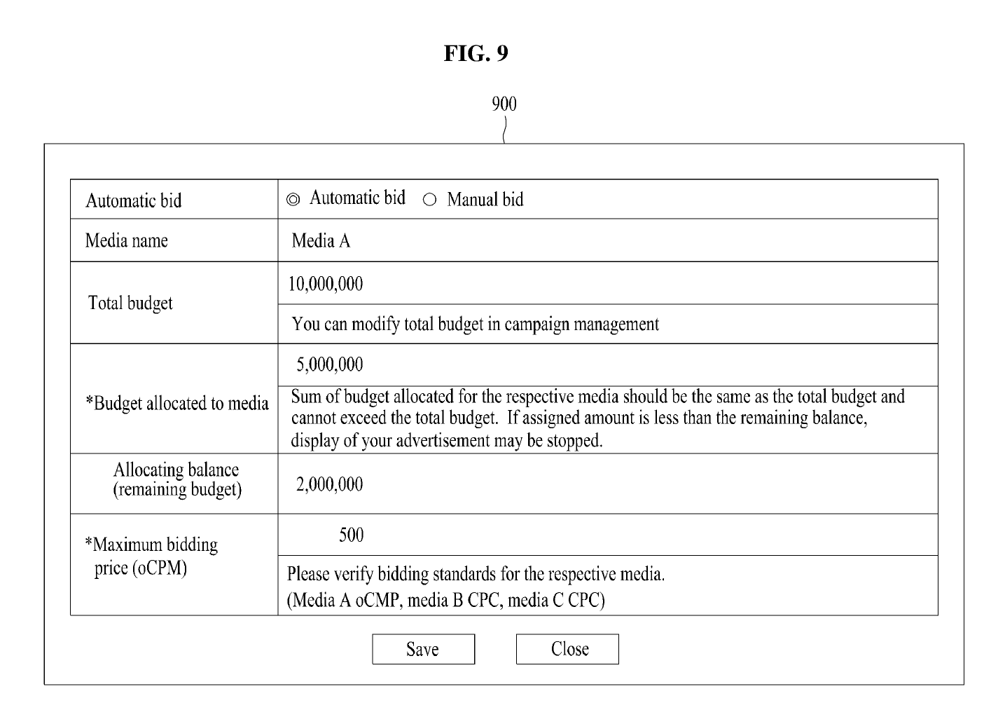

FIG. 9 illustrates an example of a screen for modifying advertising cost and bidding price of an advertising product for respective media according to some exemplary embodiments.

Referring to FIG. 9, a bidding scheme for displaying advertisement A through media A (for example, Facebook, Google, Cowley, etc.) may be set as an automatic bid. A screen 900 may include total budget that is set when the advertisement A is registered. Here, a marketer or an advertiser may manually adjust and input maximum bidding price of the advertisement A through the media A. The advertisement A may be displayed through other media, for example, media B, media C, and the like, in addition to the media A. The total budget, the maximum bidding price, and the balance of the advertisement A may be different for the respective media. Accordingly, the screen 900 may provide convenience so that the media A may verify bidding standards of other advertising media associated with bidding of the advertisement A.

According to exemplary embodiments, it is possible to efficiently perform advertising by primarily executing advertising through grouping, based on a segment unit, similar users corresponding to a targeting condition set by an advertiser based on ADIDs of collected user data, and by secondarily assigning an additional display opportunity to a segment having a relatively high advertising efficiency based on information that is fed back in response to the advertising execution. That is, a marketer is not involved manually, but, instead, a system may automatically adjust a bidding price and may automatically transfer the budget of a segment having a relatively low advertising efficiency to a segment having a relatively high advertising efficiency. Accordingly, it is possible to increase an advertising efficiency by retrieving a segment further suitable for an optimization of the advertiser and by controlling a target advertising product of the advertiser to be displayed on the segment.

The function blocks, units, and/or modules described herein may be implemented using hardware components, software components, firmware components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an OS and one or more software applications that run on the OS. The processing device also may access, store, manipulate, process, and create data in response to execution of the software. For descriptive and illustrative convenience, the description and illustration of a processing device is done in the singular; however, one skilled in the art will appreciate that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over a network coupled a computer system so that the software is stored and executed in a distributed fashion. In particular, the software and data may be stored by one or more computer-readable recording media.

Exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for purposes described herein, or they may be of the kind well-known and available to those having ordinary skill in the art. Examples of non-transitory computer-readable media include magnetic media, such as hard disks, floppy disks, and magnetic tape; optical media, such as CD ROM disks and DVD; magneto-optical media, such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A computer-implemented method of providing an advertising product, the computer-implemented method comprising:
generating a plurality of segments by grouping similar users among a plurality of users based on a targeting condition of an advertiser;
displaying a target advertising product of the advertiser for each segment of the plurality of segments;
receiving feedback information according to display of the target advertising product for each segment of the plurality of segments; and
adjusting the display of the target advertising product for each segment of the plurality of segments based on an efficiency of the feedback information.

2. The computer-implemented method of claim 1, wherein adjusting the display comprises increasing the display of the target advertising product with respect to a segment of which the efficiency of the feedback information is greater than or equal to a defined reference efficiency.

3. The computer-implemented method of claim 1, wherein adjusting the display comprises suspending the display of the target advertising product with respect to a segment of which the efficiency of the feedback information is less than a defined reference efficiency.

4. The computer-implemented method of claim 3, wherein adjusting the display comprises transferring a budget related to the target advertising product corresponding to the segment of which the display is suspended to a segment having a highest efficiency.

5. The computer-implemented method of claim 1, wherein generating the plurality of segments comprises generating a new segment in response to a number of installations over a number of displays to each segment of the plurality of segments being less than a defined reference value based on the feedback information.

6. The computer-implemented method of claim 1, wherein receiving the feedback information comprises:
receiving a number of displays and a number of clicks of the target advertising product for each segment of the plurality of segments; and
receiving a number of installations and sales information of the target advertising product for each user among the plurality of users.

7. The computer-implemented method of claim 1, wherein adjusting the display comprises adjusting a bidding price for each segment of the plurality of segments based on the efficiency of the feedback information.

8. The computer-implemented method of claim 1, wherein generating the plurality of segments comprises:
extracting an advertising identifier (ID) corresponding to ID information of each user of the plurality of users from data corresponding to the plurality of users;
determining, based on the advertising ID, users that installed the target advertising product among the plurality of users;
determining, based on a logistic regression, a probability that remaining users excluding the determined users from among the plurality of users will install the target advertising product; and
generating the plurality of segments based on the determined probability.

9. The computer-implemented method of claim 1, wherein displaying the target advertising product comprises controlling the target advertising product to be displayed to a segment that is selected from among the plurality of segments based on a conversation rate that is an occurrence rate of an optimization option set by the advertiser over a number of displays of the target advertising product.

10. A non-transitory computer-readable storage medium comprising instructions that, in response to being executed by a processor, cause the processor to perform a method of providing an advertising product, the method comprising:
generating a plurality of segments by grouping similar users among a plurality of users based on a targeting condition of an advertiser;
displaying a target advertising product of the advertiser to each segment of the plurality of segments;
receiving feedback information according to display of the target advertising product to each segment of the plurality of segments; and
adjusting the display of the target advertising product for each segment based on an efficiency of the feedback information.

11. An advertising product providing system comprising:
at least one processor; and
at least one memory comprising one or more sequences of one or more instructions that, in response to being executed by the at least one processor, cause the advertising product providing system at least to:
generate a plurality of segments by grouping similar users among a plurality of users based on a targeting condition of an advertiser;
control display of a target advertising product of the advertiser for each segment of the plurality of segments;
receive feedback information according to the display of the target advertising product for each segment of the plurality of segments; and
control adjustment of the display of the target advertising product for each segment of the plurality of segments based on an efficiency of the feedback information.

12. The advertising product providing system of claim 11, wherein the at least one memory and the one or more sequences of one or more instructions are further configured to, in response to being executed by the at least one processor, cause the advertising product providing system at least to control an increase in the display of the target advertising product with respect to a segment of which the efficiency of the feedback information is greater than or equal to a defined reference efficiency.

13. The advertising product providing system of claim 11, wherein the at least one memory and the one or more sequences of one or more instructions are further configured to, in response to being executed by the at least one processor, cause the advertising product providing system at least to control a suspension of the display of the target advertising product with respect to a segment of which the efficiency of the feedback information is less than a defined reference efficiency.

14. The advertising product providing system of claim 13, wherein the at least one memory and the one or more sequences of one or more instructions are further configured to, in response to being executed by the at least one processor, cause the advertising product providing system at least to transfer a budget related to the target advertising product corresponding to the segment of which the display is suspended to a segment having a highest efficiency.

15. The advertising product providing system of claim 11, wherein the at least one memory and the one or more sequences of one or more instructions are further configured to, in response to being executed by the at least one processor, cause the advertising product providing system at least to generate a new segment in response to a number of installations over a number of displays to each segment of the plurality of segments being less than a defined reference value based on the feedback information.

16. The advertising product providing system of claim 11, wherein the at least one memory and the one or more sequences of one or more instructions are further configured to, in response to being executed by the at least one processor, cause the advertising product providing system at least to:
receive a number of displays and a number of clicks of the target advertising product for each segment of the plurality of segments; and
receive a number of installations and sales information of the target advertising product for each user among the plurality of users.

17. The advertising product providing system of claim 11, wherein the at least one memory and the one or more sequences of one or more instructions are further configured to, in response to being executed by the at least one processor, cause the advertising product providing system at least to adjust a bidding price for each segment of the plurality of segments based on the efficiency of the feedback information.

18. The advertising product providing system of claim 11, wherein the at least one memory and the one or more sequences of one or more instructions are further configured to, in response to being executed by the at least one processor, cause the advertising product providing system at least to:
extract an advertising identifier (ID) corresponding to ID information of each user of the plurality of users from data corresponding to the plurality of users;
determine, based on the advertising ID, users that installed the target advertising product among the plurality of users;
determine, based on a logistic regression, a probability that remaining users excluding the determined users from among the plurality of users will install the target advertising product; and
generate the plurality of segments based on the determined probability.

19. The advertising product providing system of claim 11, wherein the at least one memory and the one or more sequences of one or more instructions are further configured to, in response to being executed by the at least one processor, cause the advertising product providing system at least to control the target advertising product to be displayed to a segment that is selected from among the plurality of segments based on a conversation rate that is an occurrence rate of an optimization option set by the advertiser over a number of displays of the target advertising product.
